(19) United States
(12) Patent Application Publication
(10) Pub. No.: US 2019/0069121 A1
(43) Pub. Date: Feb. 28, 2019

(54) DIRECT UPDATE OF MOBILE APPLICATIONS BASED ON FEATURES USED

(71) Applicant: INTERNATIONAL BUSINESS MACHINES CORPORATION, Armonk, NY (US)

(72) Inventors: Sumant A. Kulkarni, Bangalore (IN); Anoop G.M. Ramachandra, Mysore (IN); Norton Samuel A. Stanley, Bangalore (IN)

(21) Appl. No.: 15/682,984

(22) Filed: Aug. 22, 2017

(51) Int. Cl. H04W 4/00; G06F 9/445; G06F 17/30; H04L 29/08

(52) U.S. Cl. CPC H04W 4/001; G06F 8/67; H04L 67/025; H04L 67/327; G06F 17/30365

(57) ABSTRACT

According to one embodiment, a method, computer system, and computer program product for directing an update of a mobile application based on one or more modules chosen by a user is provided. An embodiment may include receiving a user module preference for the mobile application based on a user input, may also include storing the received user module preference in a database, may include receiving an update for one or more modules within the mobile application from an administrator of the mobile application, and may also include transmitting the received update for the mobile application to one or more user devices based on the received user module preference.

### BACKGROUND

The present invention relates, generally, to the field of computing, and more particularly to mobile application updates.

A mobile application is a software application designed to run on a mobile device. In many instances, mobile applications serve to provide users with similar services to those accessed on desktop computers. A mobile application that is developed specifically for one platform can take full advantage of all features of a mobile device, including the camera, the GPS, the list of contacts, and more. Companies and businesses can offer mobile applications as an alternative method to deliver content to the user that does not require accessing an official website. Regular mobile application updates are required to maintain and support the mobile application. Mobile application updates function as a marketing tool, a bug-fixer, and a way to communicate new information to the user.

### SUMMARY

According to one embodiment, a method, computer system, and computer program product for directing an update of a mobile application based on one or more modules chosen by a user is provided. An embodiment may include receiving a user module preference for the mobile application based on a user input, may also include storing the received user module preference in a database, may include receiving an update for one or more modules within the mobile application from an administrator of the mobile application, and may also include transmitting the received update for the mobile application to one or more user devices based on the received user module preference.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an update evaluation process according to at least one embodiment;

FIG. 3 is a functional block diagram of an update evaluation process according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

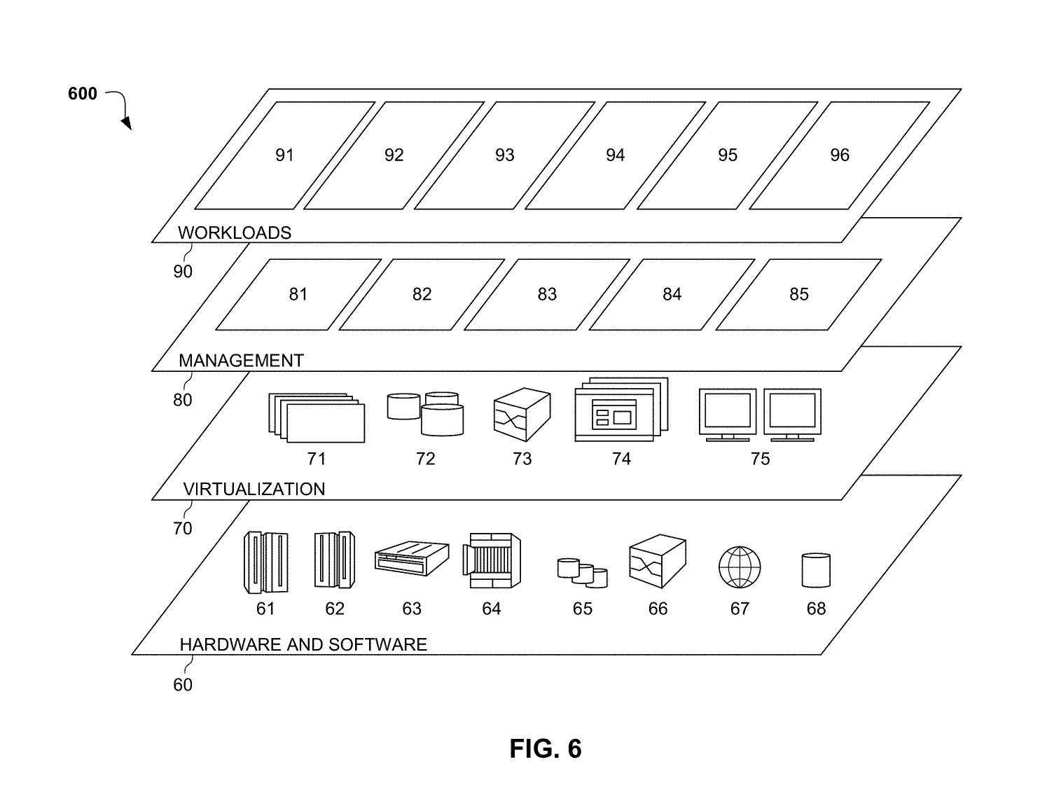

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to mobile applications. The following described exemplary embodiments provide a system, method, and program product to, among other things, direct the update of mobile applications based on features employed by the user. Therefore, the present embodiment has the capacity to improve the technical field of mobile applications by updating only the features of a mobile application employed by a user, thereby minimizing the storage needed for application updates and enhancing the user application experience.

As previously described, in many instances, a mobile application is a software application designed to run on a mobile device. Mobile applications serve to provide users with similar services to those accessed on desktop computers. A mobile application that is developed specifically for one platform can take full advantage of all features of a mobile device, including the camera, the GPS, the list of contacts, and more. Companies and businesses can offer mobile applications as an alternative method to deliver content to the user that does not require accessing an official website. Regular mobile application updates are required to maintain and support the mobile application. Mobile application updates function as a marketing tool, a bug-fixer, and a way to communicate new information to the user. Each mobile application update consumes space on the memory of the mobile device, which can result in unwanted memory usage on the mobile device.

A user of a mobile application may often receive updates for all features of the application, even those not employed by the user. For example, an insurance company may offer different types of insurance, such as home insurance, life insurance, and automobile insurance, that each have a separate module within a mobile application. When the insurance company updates the policy for vehicle insurance and opts to deliver the updated policy to users via a direct update of the mobile application, the update can reach the users of every module within the mobile application, including home insurance and life insurance. However, this update may occupy valuable space on the mobile device memory for a user, regardless of whether the user holds vehicle insurance from the company. For a user, downloading irrelevant mobile application updates can result in unnecessary usage of bandwidth and space. As such, it may be advantageous to, among other things, implement a system capable of using a modularized mobile application to transmit mobile application updates only to those users who employ the relevant updated module.

According to one embodiment, a mobile application developer may provide a list of all the modules in the mobile application. The user of the mobile application can choose one or more modules to use. The user module preferences can be changed by the user at any time. The server may receive the user module preferences and store the user module preferences in a database. A mobile application update may be received by the server from the administrator of the mobile application. The database, which stores user module preferences, may be accessed by the server to determine which mobile applications are employed by the user. The updates to the mobile application may be transmitted to the user and may be installed for only the modules indicated in the user module preferences.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to transmit mobile application updates to users based on the features of the application employed by the user.

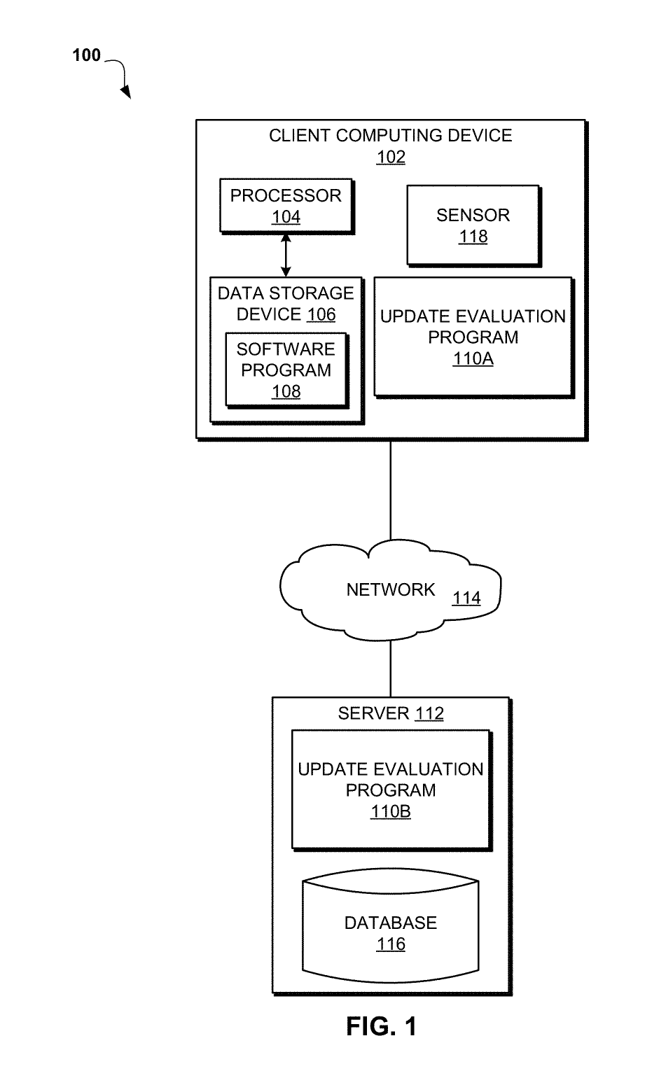

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

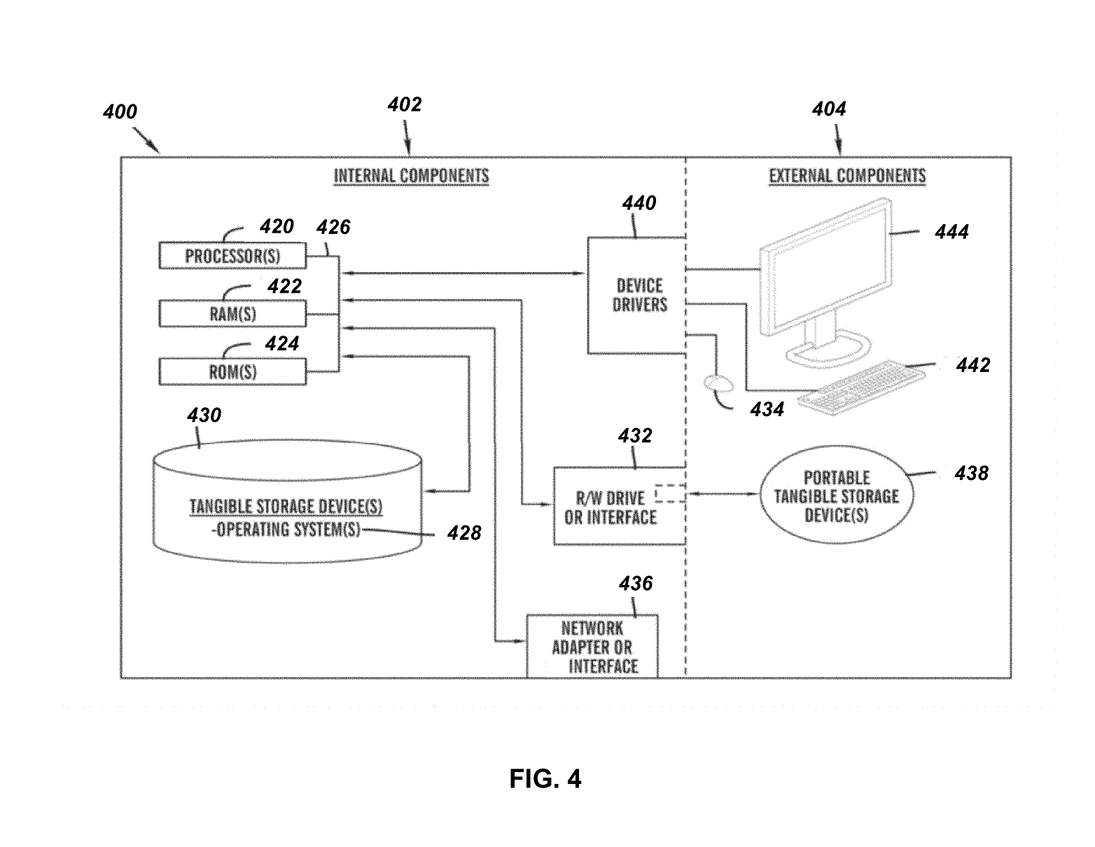

Client computing device 102 may include a processor 104 and a data storage device 106 that is enabled to host and run a software program 108 and an update evaluation program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running an update evaluation program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

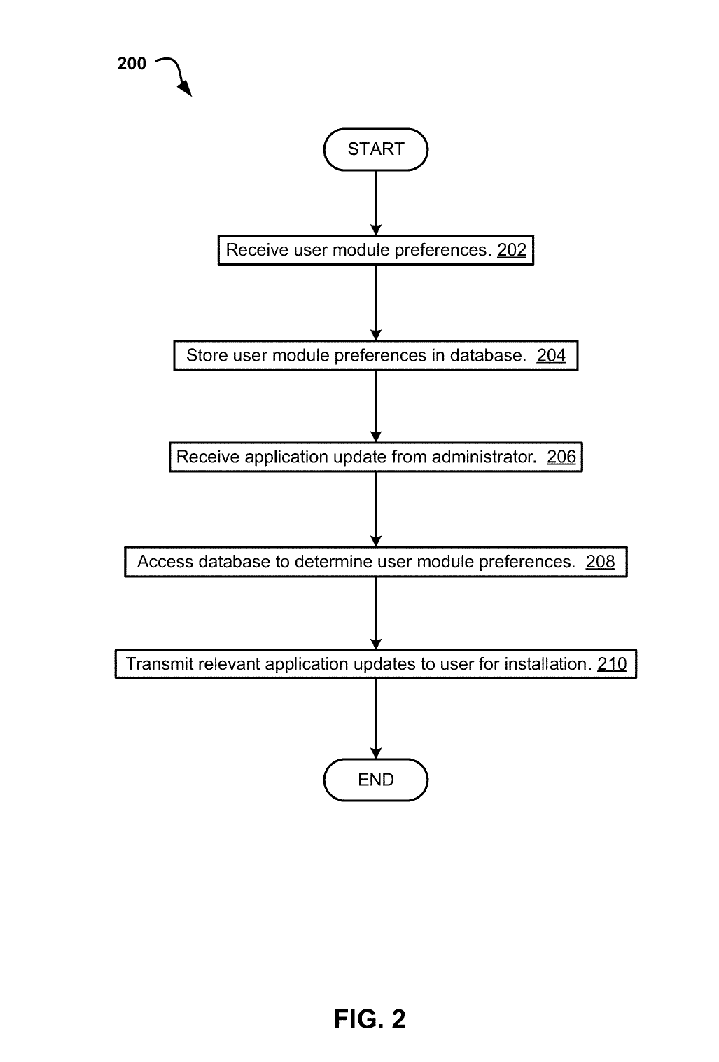

According to the present embodiment, the update evaluation program 110A, 110B may be a program capable of selectively updating a mobile application based on user preferences. The update evaluation method is explained in further detail below with respect to FIG. 2.

Referring now to FIG. 2, an operational flowchart illustrating an update evaluation process 200 is depicted according to at least one embodiment. At 202, the update evaluation program 110A, 110B receives the user module preferences. Each module of a mobile application may represent a specific feature of the mobile application. For example, a mobile application for an insurance company may have modules for home insurance, life insurance, and vehicle insurance. A mobile application may be developed using a module interface provided by a client software development kit that lists all application modules in an extensible markup language (XML) file. The mobile application may be deployed to the server to be downloaded by a user. When the user installs the mobile application on the mobile device, the application may display a list of modules based on the modules from the XML file. The user may select the preferred modules from the list and submit the user module preferences to the server. For instance, User A may choose to only receive updates for the home insurance module of the application. In another embodiment, the user may alter module preferences by accessing the settings for the mobile application.

Next, at 204, the update evaluation program 110A, 110B stores the user module preferences in a database 116. The database 116, such as data storage device 106 or database 116, may be a data store that may store the user module preferences for each user. For example, the database 116 may store the user module preferences for User A as “home insurance.” When the user module preferences are stored in the database 116, each module preference may be stored using application programming interfaces (APIs) such as the modularization code:

subscribeModule(Module module, WLModuleListener wlModuleListener)
subscribeModule(Module[ ] modules)

And the client side modularization code may include:

```
        try {
          WLModuleRequest request = new WLModuleRequest ( );
Module module = new Module (&module18);
          request.send(module, new WLModuleListener( ) { @Override
public void onSuccess(final WLModuleResponse
wlModuleResponse) {
          //do something here } @Override
public void onFailure(final WLModuleFailResponse
wlModuleFailResponse) {
          //take require actions } });} catch
        (URISyntaxException e) { e.printStackTrace( );}
```

In at least one embodiment, the database 116 can be updated each time a user alters the user module preferences. For example, User A might later decide to also take out a life insurance policy with the insurance company. User A could access the settings within the mobile application and select “life insurance” as a module preference, along with the previously chosen “home insurance”.

Next, at 206, the update evaluation program 110A, 110B receives an application update from the administrator of the mobile application. During the course of a mobile application's lifecycle, an administrator or developer may create an update that improves functionality or application features. Updates might include bug fixes, security updates, privacy policy updates, a new application feature or capability, or messages from the administrator of the mobile application. For example, the administrator of the mobile application for the insurance company may transmit updated policy information for the home insurance, vehicle insurance, and life insurance modules.

Next, at 208, the update evaluation program 110A, 110B accesses the database 116 to determine the stored user module preferences. For example, the update evaluation program 110A, 110B could determine that User A only requires the updated policy for the home insurance module and does not require the updated policy for the life insurance module or the vehicle insurance module. The update evaluation program 110A, 110B may use the user module preferences as chosen by the user from the previously described list of modules from the XML file.

Next, at 210, the update evaluation program 110A, 110B transmits the relevant application updates to the user for installation. The update evaluation program 110A, 110B may use the database 116 to identify all of the mobile devices that have chosen the newly updated module in the user module preferences. The update evaluation program 110A, 110B may send the updated module directly to only those devices which have listed the module in the user module preferences. This application update may be installed on the client computing device 102. For example, the update evaluation program 110A, 110B may transmit the home insurance policy update to User A, which may then become available to the user within the mobile application interface.

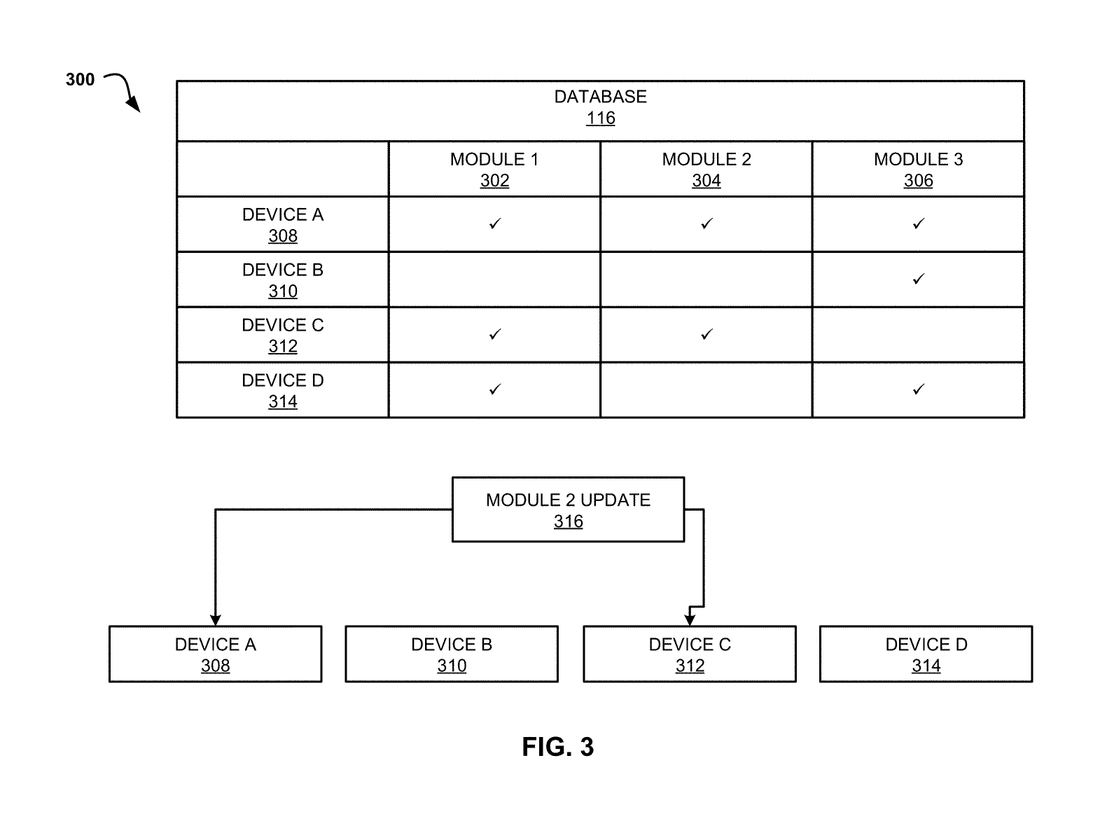

Referring now to FIG. 3, functional block diagram of an update evaluation process 300 is depicted according to at least one embodiment. The update evaluation environment 300 may include a database 116, mobile application modules (e.g., Module 1 302, Module 2 304, and Module 3 306), Device A 308, Device B 310, Device C 312, Device D 314, and a module update 316. As previously described, the database 116 may be a data repository that may store the user module preferences for each user. Each user can be identified by a mobile device, such as Device A 308, Device B 310, Device C 312, and Device D 314. Additionally, the database 116 may store the module preferences for each mobile device. For example, a mobile application may include Module 1 302, Module 2 304, and Module 3 306. When the update evaluation program 110A, 110B receives an application update from the administrator of the mobile application, the update evaluation program 110A, 110B can access the database 116 to determine which mobile device 302-306 requires the mobile application update. For example, when the administrator of the mobile application transmits Module 2 Update 316, the update evaluation program 110A, 110B may transmit the Module 2 Update 316 to Device A 308 and Device C 312 since Device A 308 and Device C 312 both selected Module 2 304 in the user module preferences.

It may be appreciated that FIGS. 2-3 provide only an illustration of one implementation and does not imply any limitations with regard to how different embodiments may be implemented. Many modifications to the depicted environments may be made based on design and implementation requirements. In an alternate embodiment, the update evaluation program 110A, 110B is capable of being scaled up or down to other applications. For example, the update evaluation program 110A, 110B could be implemented on a mobile application that facilitates communication between users in different countries. In such a mobile application, separate functions may be utilized for video calling, document sharing, and text messaging. Each of these functions may be modularized in order to integrate the update evaluation program 110A, 110B into the functionality of the mobile application. In another embodiment, the update evaluation program 110A, 110B may be incorporated into a preexisting mobile application after the development of the application. For example, the administrator of a preexisting mobile application could transmit an update to every user that incorporates the previously described code. Each user may then be prompted to select the preferred modules based on the XML file as previously described.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the update evaluation program 110A in the client computing device 102, and the update evaluation program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the update evaluation program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the update evaluation program 110A in the client computing device 102 and the update evaluation program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the update evaluation program 110A in the client computing device 102 and the update evaluation program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

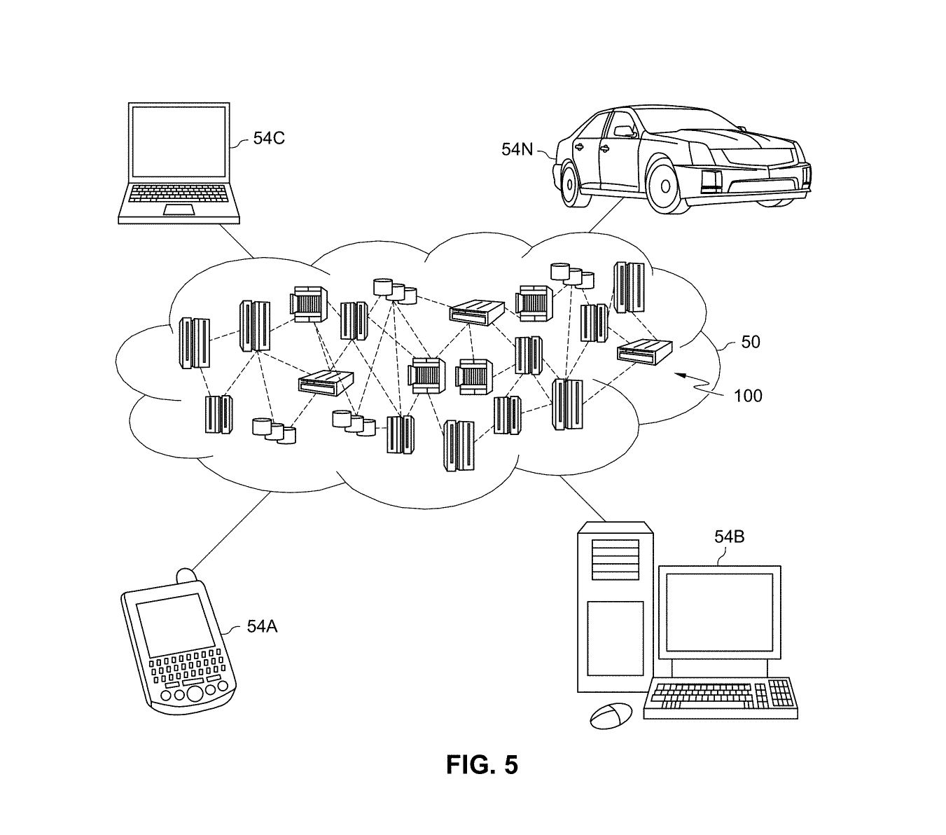

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and update evaluation 96. Update evaluation 96 may relate to implementing a system that can selectively transmit updates to a user based on the features of a mobile application employed by the user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method for directing an update of a mobile application based on one or more modules chosen by a user, the method comprising:
modularizing the mobile application into one or more modules based on a plurality of application functionalities;
determining a user utilization of a module within the one or more modules;
storing the user utilization of the module in a database;
receiving an update for the module from an administrator of the mobile application; and
in response to the user utilizing the module, transmitting the received update for the mobile application to one or more user devices associated with the user.

2. The method of claim 1, further comprising:
transmitting a modularization code to the administrator of the mobile application, wherein the modularization code is an extensible markup language file that lists one or more modules.

3. The method of claim 1, wherein the user module preference is input by the user via an extensible markup language file that lists one or more modules.

4. The method of claim 1, further comprising:
accessing the database to identify one or more users that identified the one or more modules in the received user module preference.

5. The method of claim 1, wherein a module is a feature capable of being executed by the mobile application.

6. The method of claim 1, wherein the update for one or more modules is selected from a group consisting of a bug fix, a security update, a privacy policy update, a new application feature, a new application capability, and a message from the administrator of the mobile application.

7. The method of claim 1, further comprising:
installing the received update for the mobile application on a mobile device of each user.

8. A computer system for directing an update of a mobile application based on one or more modules chosen by a user, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
modularizing the mobile application into one or more modules based on a plurality of application functionalities;
determining a user utilization of a module within the one or more modules;
storing the user utilization of the module in a database;
receiving an update for the module from an administrator of the mobile application; and
in response to the user utilizing the module, transmitting the received update for the mobile application to one or more user devices associated with the user.

9. The computer system of claim 8, further comprising:
transmitting a modularization code to the administrator of the mobile application, wherein the modularization code is an extensible markup language file that lists one or more modules.

10. The computer system of claim 8, wherein the user module preference is input by the user via an extensible markup language file that lists one or more modules.

11. The computer system of claim 8, further comprising:
accessing the database to identify one or more users that identified the one or more modules in the received user module preference.

12. The computer system of claim 8, wherein a module is a feature capable of being executed by the mobile application.

13. The computer system of claim 8, wherein the update for one or more modules is selected from a group consisting of a bug fix, a security update, a privacy policy update, a new application feature, a new application capability, and a message from the administrator of the mobile application.

14. The computer system of claim 8, further comprising:
installing the received update for the mobile application on a mobile device of each user.

15. A computer program product for directing an update of a mobile application based on one or more modules chosen by a user, the computer program product comprising:
one or more computer-readable tangible storage medium and program instructions stored on at least one of the one or more tangible storage medium, the program instructions executable by a processor, the program instructions comprising:
modularizing the mobile application into one or more modules based on a plurality of application functionalities;
determining a user utilization of a module within the one or more modules;
storing the user utilization of the module in a database;
receiving an update for the module from an administrator of the mobile application; and
in response to the user utilizing the module, transmitting the received update for the mobile application to one or more user devices associated with the user.

16. The computer program product of claim 15, further comprising:
transmitting a modularization code to the administrator of the mobile application, wherein the modularization code is an extensible markup language file that lists one or more modules.

17. The computer program product of claim 15, wherein the user module preference is input by the user via an extensible markup language file that lists one or more modules.

18. The computer program product of claim 15, further comprising:
accessing the database to identify one or more users that identified the one or more modules in the received user module preference.

19. The computer program product of claim 15, wherein a module is a feature capable of being executed by the mobile application.

20. The computer program product of claim 15, wherein the update for one or more modules is selected from a group consisting of a bug fix, a security update, a privacy policy update, a new application feature, a new application capability, and a message from the administrator of the mobile application.
